(19) United States
(12) Patent Application Publication
(10) Pub. No.: US 2018/0365146 A1
(43) Pub. Date: Dec. 20, 2018

(54) IDENTIFICATION OF SOFTWARE COMPONENTS WITH EVENT PERSISTENCY ACROSS OPERATION INTERRUPTIONS

(71) Applicant: INTERNATIONAL BUSINESS MACHINES CORPORATION, Armonk, NY (US)

(72) Inventors: Piotr Godowski, Krakow (PL); Grzegorz Majka, Krakow (PL); Artur Obrzut, Krakow (PL); Luigi Pichetti, Rome (IT)

(21) Appl. No.: 15/694,782

(22) Filed: Sep. 2, 2017

(30) Foreign Application Priority Data
Jun. 20, 2017 (GB) 1709813.8

(51) Int. Cl. G06F 12/0804; G06F 3/06; G06F 9/48

(52) U.S. Cl. CPC G06F 12/0804; G06F 3/065; G06F 3/0619; G06F 2212/205; G06F 9/4812; G06F 2212/1032; G06F 3/067

(57) ABSTRACT

An embodiment of the invention may include a method, computer program product, and system for improving I/O performance in a heterogeneous storage environment. The embodiment may include storage devices of different storage device types having different I/O performances. Each of the storage devices is accessible via a SAS interface. The embodiment may include identifying a plurality of storage devices of the heterogeneous storage environment. The embodiment may include creating a table including information about identifiable storage devices and attributes. The embodiment may include separating a block I/O data stream into storage device type classes. The embodiment may include routing I/O requests of corresponding device type classes to their assigned physical lanes using the information included in the table, thereby improving the I/O performance of the heterogeneous storage environment.

### BACKGROUND

The present disclosure relates to the information technology field. More specifically, this disclosure relates to the identification of software components in computing systems.

### BRIEF SUMMARY

A simplified summary of the present disclosure is herein presented in order to provide a basic understanding thereof; however, the sole purpose of this summary is to introduce some concepts of the disclosure in a simplified form as a prelude to its following more detailed description, and it is not to be interpreted as an identification of its key elements nor as a delineation of its scope.

In general terms, the present disclosure is based on the idea of persisting the events.

Particularly, an aspect of the present disclosure provides a method for identifying software components in a computing system, where any pending events (of events to be monitored and processed for use to identify the software components, whose processing has not been completed yet) are saved from a volatile memory to a non-volatile memory of the computing system in response to an interruption of operation of the computing system being initiated. An aspect of the present invention may include restoring the pending events from the non-volatile memory to the volatile memory for their processing in response to a restarting of the operation of the computing system.

A further aspect of the present disclosure provides a corresponding computer program product for implementing the method.

A further aspect of the present disclosure provides a corresponding system.

More specifically, one or more aspects of the present disclosure are set out in the independent claims and advantageous features thereof are set out in the dependent claims, with the wording of all the claims that is herein incorporated verbatim by reference (with any advantageous feature provided with reference to any specific aspect that applies mutatis mutandis to every other aspect).

### BRIEF DESCRIPTION OF THE DRAWINGS

The solution of the present disclosure, as well as further features and the advantages thereof, will be best understood with reference to the following detailed description thereof, given purely by way of a non-restrictive indication, to be read in conjunction with the accompanying drawings (wherein, for the sake of simplicity, corresponding elements are denoted with equal or similar references and their explanation is not repeated, and the name of each entity is generally used to denote both its type and its attributes—such as value, content and representation). Particularly:

FIG. 1A-FIG. 1D shows the general principles of the solution according to an embodiment of the present disclosure;

FIG. 2 shows a schematic block diagram of a computing infrastructure wherein the solution according to an embodiment of the present disclosure may be applied;

FIG. 3 shows the main software components that may be used to implement the solution according to an embodiment of the present disclosure; and

FIG. 4A-FIG. 4B shows an activity diagram describing the flow of activities relating to an implementation of the solution according to an embodiment of the present disclosure.

### DETAILED DESCRIPTION

The background of the present disclosure is hereinafter introduced with the discussion of techniques relating to its context. However, even when this discussion refers to documents, acts, artifacts and the like, it does not suggest or represent that the discussed techniques are part of the prior art or are common general knowledge in the field relevant to the present disclosure.

The identification of software components in computing systems, or simply computers, is a commonplace activity in several applications.

A typical example is the identification of malwares (for example, viruses, worms, Trojan horses) that might perform malicious operations on the computers. This is important for ensuring security of the computers, especially when they are routinely used to access external networks (like the Internet).

For this purpose, anti-malwares (such as anti-viruses) are commonly used to protect the computers from malwares; the anti-malwares are aimed at preventing the installation of malwares, detecting activities performed by them and removing their threads. Particularly, the anti-malware of each computer may provide real-time protection by monitoring the computer for events relating to its software components (for example, their deployment, opening or execution); the events are then analyzed to verify whether they are indicative of suspicious activities involving malwares. For this purpose, the anti-malware identifies the malwares according to corresponding signatures, for example, defined by their (cryptographic) hash values, or simply hashes. Particularly, the anti-malware has a signature database (being continually updated for new malwares) that stores the hashes of all the known malwares. During the real-time monitoring of the computer, the anti-malware calculates the hash of each software component currently under analysis; the software component is identified as a malware whenever a match of its hash is found in the signature database. In this case, the anti-malware neutralizes the malware, for example, by preventing its installation, deleting it or moving it to a quarantine area (wherein the malware is no longer capable of damaging the computer). Moreover, the anti-malware may be used to scan (for example, periodically) the computer to detect and neutralize as above any malwares that are found.

Moreover, several organizations (such as private or public companies) have policies that prevent the use of unauthorized software programs on their computers; typically, these unauthorized software programs are unrelated to an activity of the organization (such as games, social networks) or do not comply with applicable license conditions (such as for private use only). For this purpose, a management agent running on each computer monitors the events relating to the software programs that are deployed thereon (for example, downloaded from the Internet); the events are then analyzed to verify the corresponding software programs against a blacklist (or block list) of the unauthorized software programs. For this purpose, the monitoring agent identifies the unauthorized software programs as above according to corresponding signatures (for example, defined by their hashes or names/sizes). Whenever a match of each software program is found in the blacklist, the monitoring agent denies its installation on the computer.

A similar technique may also be used to identify legitimate software programs that are installed on each computer (for example, for ensuring compliance with applicable license conditions); in this case, the signatures of the software programs relating to the events being monitored are verified against a whitelist of the legitimate software programs that are authorized in the organization.

In any case, any loss should be avoided of the events that are still to be processed (for identifying the corresponding software components). Indeed, this might prevent the identification of the software components, or at least significantly delay it. All of the above is particularly important in case of the malwares, which should be detected and then neutralized as soon as possible.

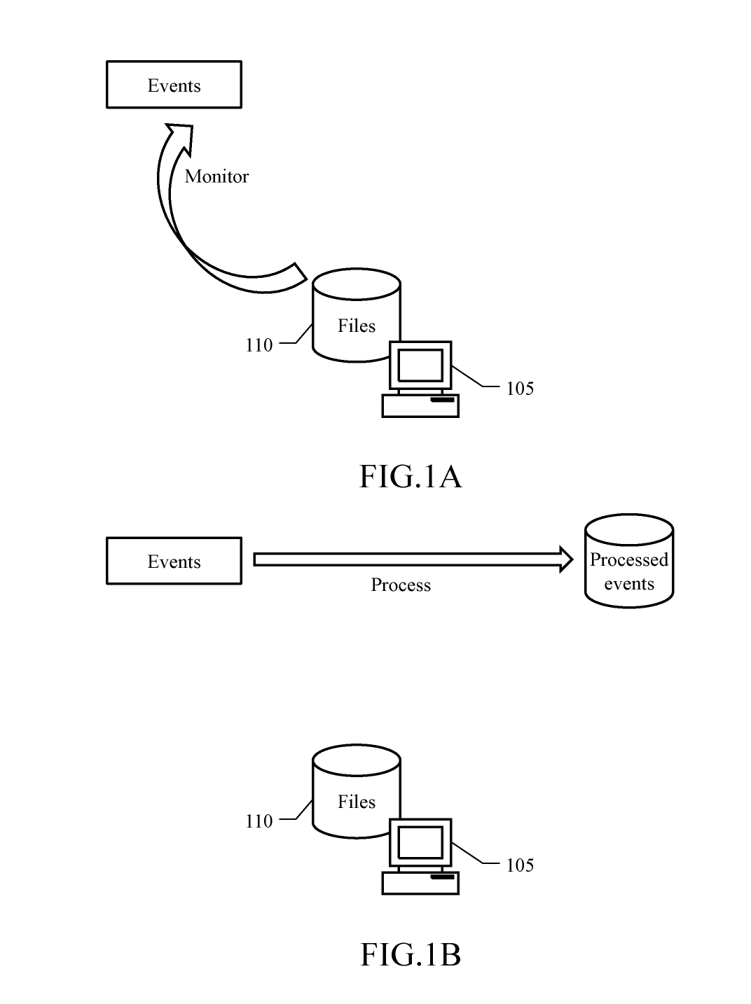

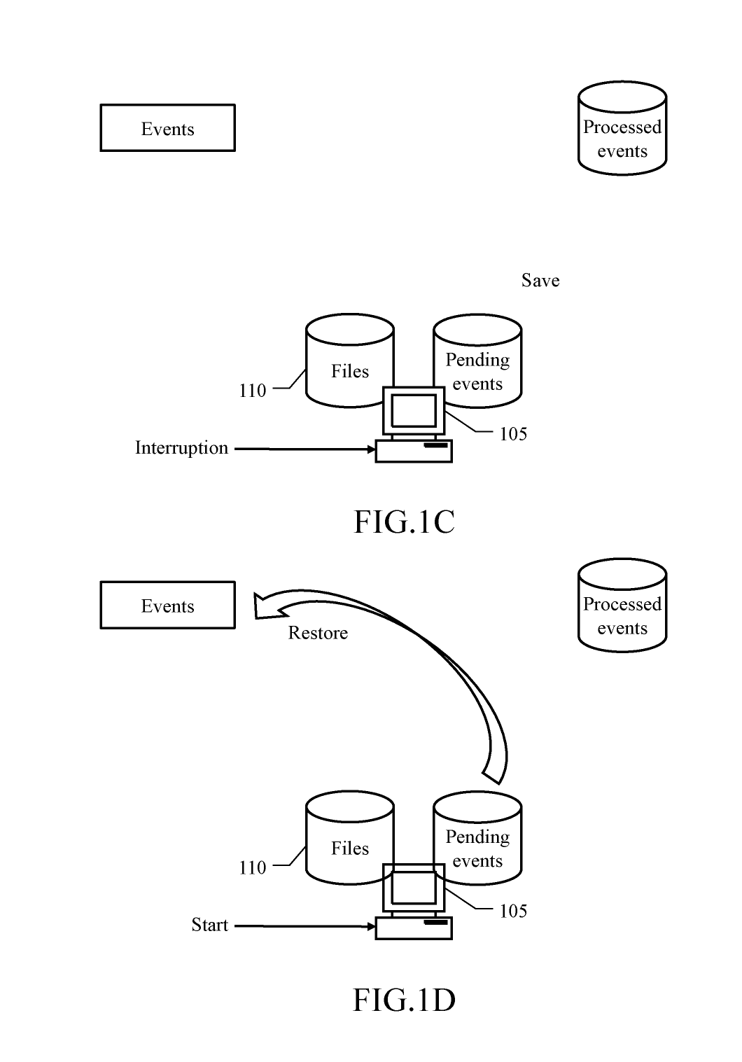

With reference in particular to FIG. 1A-FIG. 1D, the general principles are shown of the solution according to an embodiment of the present disclosure.

Starting from the FIG. 1A, events are monitored on a computing system, for example, each of multiple endpoints (or targets) 105 of a resource management application (not shown in the figure). The events relate to software components, for example, files 110 of the endpoint 105; typically, the events indicate that the files 110 are created, opened, modified, renamed, deleted, closed, and so on. For example, the events may be monitored by listening for corresponding notifications that are generated by an operating system of the endpoint 105 (not shown in the figure).

Moving to FIG. 1B, the events are processed for their use to identify the files 110. For example, the events are filtered to maintain only finalizing events of event sequences relating to logical operations of corresponding files 110. A typical scenario is when a file 110 is copied to the computer 105, where the events relating to the creation of the file 110 (empty or with a minimum size) and to the writing of its blocks are discarded thereby maintaining the (finalizing) event relating to its closing only. The (filtered) events so obtained are then enriched with additional information relating to the corresponding files 110 (for use to identify them). For example, a signature of the file 110 corresponding to each filtered event, such as its hash (value), is calculated according to a content of the file 110 (or a part thereof). The hashes of the files 110 so determined may then be used for identifying them according to a comparison with known signatures of known software components, i.e., known hashes of known files in this case. The (enriched) events so processed are stored into a non-volatile memory of the computer 105 (for their next use to identify the files 110); conversely, for performance reasons, during their processing the events are loaded into a volatile memory of the computer 105 (for example, a monitoring queue for their monitoring, a filtering queue for their filtering and an enrichment queue for their enriching).

Moving to FIG. 1C, an interruption signaling, or interruption signal, is received; the interruption signaling indicates that an interruption of operation of the endpoint 105 has been initiated (for example, its shutdown). In response thereto, any (pending) events whose processing has not been completed yet are saved into the non-volatile memory of the computer 105. For example, the monitoring of the events and their processing is stopped; after that, any events in the filtering queue followed by any events in the monitoring queue are dumped to a file and any filtered events in the enrichment queue are dumped to another file.

Moving to FIG. 1D, later on the computer 105 is restarted (for example, during a reboot thereof). In response thereto, any pending events (previously saved) are restored from the non-volatile memory to the volatile memory of the computer 105 for their processing. For example, the monitoring queue is reloaded with the events from the corresponding file and the enrichment queue is reloaded with the filtered events from the corresponding file; once the reloading of the monitoring/enrichment queues has been completed, the monitoring of the events and their processing are restarted.

The above-described solution persists the pending events across any interruption and restart of the operation of the endpoint 105. As a result, any loss of the events is prevented (or at least substantially reduced). Indeed, the processing of the events, and especially the calculation of the hashes of the corresponding files 110, is relatively complex from a computational point of view; therefore, it is very likely that when an interruption of operation of the endpoint 105 is initiated the processing of the pending events may not be completed. In this way, instead, the pending events (simply saved in a very fast way), may be processed without any problem at the next restart of the endpoint 105, after their restoring.

All of the above significantly improves the accuracy and the responsiveness in the identification of the files 110. This is particularly important in case of malwares, which may be detected and then neutralized promptly.

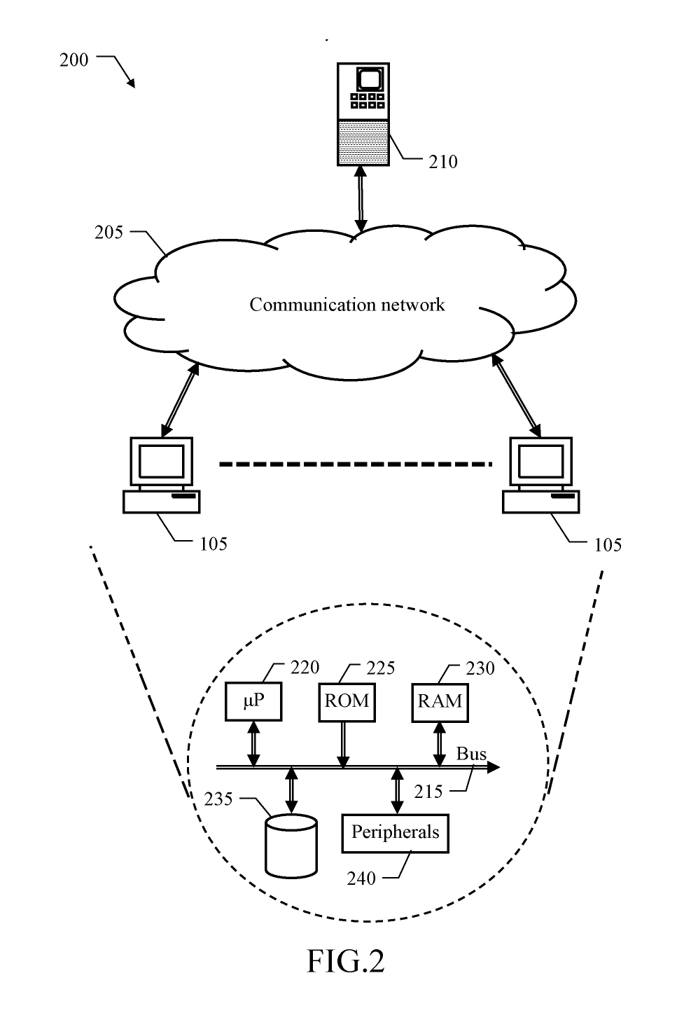

With reference now to FIG. 2, a schematic block diagram is shown of a computing infrastructure wherein the solution according to an embodiment of the present disclosure may be applied.

The computing infrastructure 200 is used to run a resource management application. The computing infrastructure 200 has a distributed architecture based on a communication network 205 (for example, the Internet). Several computing systems are connected to the communication network 205 for communicating among them (for example, through a corresponding Virtual Private Network, or VPN). Particularly, these computing systems include multiple endpoints 105 and a management server 210 (or more) of the resource management application; the management server 210 controls the management of the endpoints 105 (for example, for inventorying legitimate software programs, discovering unauthorized software programs and detecting malwares of the endpoints 105 and then causing the execution of desired management activities thereon, such as by applying corresponding management policies).

Each of the computing systems 105, 210 includes several units that are connected among them through a bus architecture 215 (with one or more levels). Particularly, one or more microprocessors (μP) 220 control operation of the computing system 105, 210; a (non-volatile) system memory (ROM) 225 stores basic code for a bootstrap of the computing system 105, 210 and a volatile memory (RAM) 230 is used as a working memory by the microprocessors 220. The computing system 105, 210 is provided with a (non-volatile) mass-memory 235 for storing programs and data; for example, the mass-memory 235 of the endpoints 105 may include solid-state disks, whereas the mass-memory 235 of the management server 210 may include storage devices of a data center wherein the management server 210 is implemented. Moreover, the computing system 105,210 includes a number of controllers for peripheral (or Input/Output, I/O) units 240; for example, the peripheral units 240 of the endpoints 105 may include a monitor, a keyboard, a mouse, a drive for reading/writing removable storage units (like DVDs) and a wireless network adapter for accessing the communication network 205, whereas the peripheral units 240 of the management server 210 may include a network adapter for plugging it into the data center and a similar drive for reading/writing removable storage units implemented by a console of the data center.

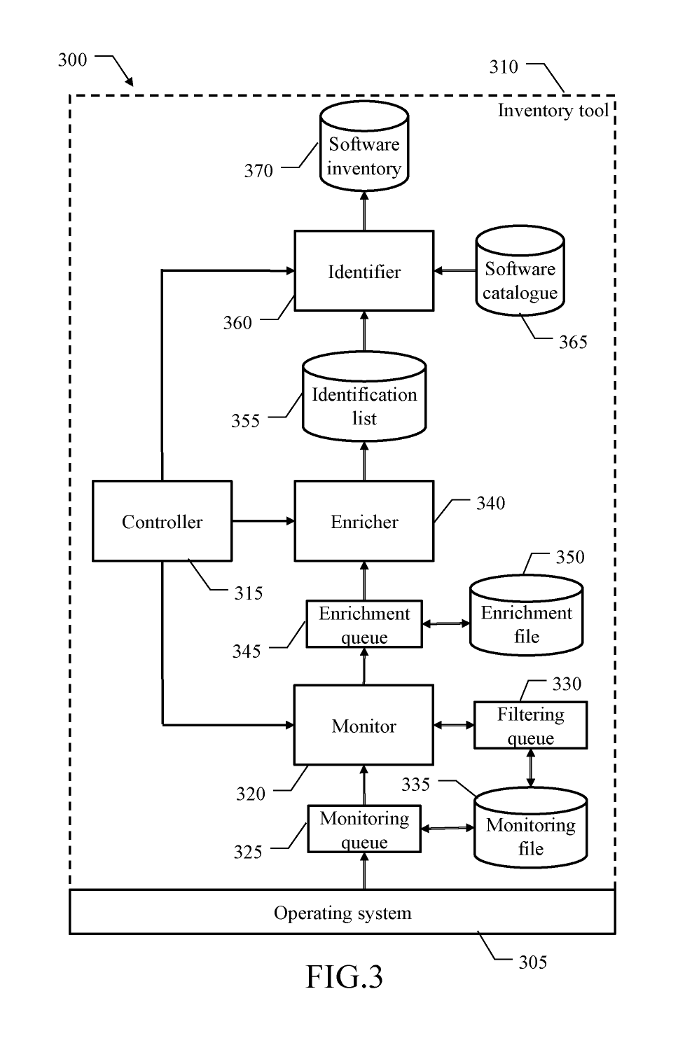

With reference now to FIG. 3, the main software components are shown that may be used to implement the solution according to an embodiment of the present disclosure.

All the software components (programs and data) are denoted as a whole with the reference 300. The software components 300 are typically stored in the mass memory and loaded (at least partially) into the working memory of each endpoint (only one shown in the figure) when the programs are running, together with any other application programs (not shown in the figure). The programs are initially installed into the mass memory, for example, from removable storage units or from the communication network. In this respect, each program may be a module, segment or portion of code, which includes one or more executable instructions for implementing the specified logical function.

Particularly, the endpoint has an operating system 305, on top of which an inventory tool 310 runs (for example, in user mode with privileges reduced with respect to a maximum level thereof in kernel mode, so as to reduce any security exposure of the endpoint). The inventory tool 310 identifies the files that are present on the endpoint for use by a server-side component of the resource management application running on the management server (not shown in the figure); commercial examples of the inventory tool 310 and of the resource management application are IBM Common Inventory Technology (CIT) and IBM BigFix, respectively, by IBM Corporation (trademarks).

The inventory tool 310 includes the following elements. A controlling module, or simply controller, 315 (running in a corresponding thread at high priority) defines a main entry point of the inventory tool 310 and is responsible for controlling all its other modules. A monitoring module, or simply monitor, 320 (running in a corresponding thread at high priority) is used to monitor and filter the events (relating to the files of the endpoint). For this purpose, the monitor 320 is registered as a listener for notifications of these events, or simply events, with the operating system 305; for example, each event includes a timestamp, a name and a path of the corresponding file and an indication of a type of the event (for example, create, open, modify, rename, delete, close). The operating system 305 and the monitor 320 share a monitoring queue 325 implemented by a FIFO register (loaded in the working memory of the endpoint), which is capable of storing a fixed number of events; the operating system 305 acts as a producer of the monitoring queue 325 (generating and adding the events to its tail), whereas the monitor 320 acts as a consumer of the monitoring queue 325 (extracting the events from its head). The monitor 320 further accesses (in read/write mode) a filtering queue 330 (implemented by a FIFO register loaded in the working memory of the endpoint, capable of storing a fixed number of events), which is used to store the events temporarily for their filtering (as described in the following). A monitoring persistency file 335 is used to save the monitoring queue 325 and the filtering queue 330 (at any interruption of operation of the endpoint) and to restore the monitoring queue 325 (at any restart of operation of the endpoint).

An enrichment module, or simply enricher, 340 (running in a corresponding thread at low priority) is used to enrich the (filtered) events with additional information for the identification of the corresponding files. For this purpose, the monitor 320 and the enricher 340 share an enrichment queue 345 (implemented by a FIFO register loaded in the working memory of the endpoint, capable of storing a fixed number of filtered events); the monitor 320 acts as a producer of the enrichment queue 345 (adding the filtered events to its tail), whereas the enricher 340 acts as a consumer of the enrichment queue 345 (removing the filtered events from its head). For each filtered event, the enricher 340 adds one or more signatures thereof and a size of the corresponding file (retrieved from the operating system 305). For example, each signature is a hash of the file (which maps a content of the file, or a portion thereof, to a string of a fixed number of bits), and particularly a cryptographic hash (which is infeasible to invert to the corresponding content of the file and unlikely to be the same for different files); for example, the cryptographic hash may be calculated with the SHA-256 and MD5 cryptographic hash functions. An enrichment persistency file 350 is used to save and to restore the enrichment queue 345 at any interruption and at any restart, respectively, of operation of the endpoint. The enricher 340 further accesses (in write mode) an identification list 355, which stores the filtered events so enriched, or simply enriched events (in the mass memory of the endpoint).

An identification module, or simply identifier, 360 (running in a corresponding thread at low priority) is used to identify the files corresponding to the enriched events (according to their hashes). For this purpose, the identifier 360 accesses (in read mode) the identification list 355. Moreover, the identifier 360 further accesses (in read mode) a software catalogue 365, for example, downloaded from the management server that maintains it up-to-date. The software catalogue 365 specifies all the known files that are to be identified according to the specific application; for example, when the inventory tool 310 is used for inventorying legitimate software programs the software catalogue 365 is a whitelist thereof (for example, maintained by a system administrator to specify the software programs that are authorized in the corresponding organization), when the inventory tool 310 is used for discovering unauthorized software programs the software catalogue 365 is a blacklist thereof (for example, maintained by the system administrator to specify the software programs that are not authorized in the corresponding organization) and/or when the inventory tool 310 is used for detecting malwares the software catalogue 365 is a signature database thereof (for example, publicly available in the Internet to specify the malwares to be neutralized). For each known file, the software catalogue 365 indicates an identifier and a (known) signature thereof. The identifier substantially and uniquely identifies the known file for use by humans (for example, its product name and version). The signature (substantially uniquely) represents a content of the known file for use by the identifier 360; for example, the signature includes the hash of the known file (i.e., its whole content or a common portion thereof in different known files of a same family, like mutations of a same malware) and the corresponding type (for example, SHA-2, MD5). The identifier 360 further accesses (in write mode) a software inventory 370, which identifies the files of the endpoint; particularly, for each file of the endpoint the software inventory 370 indicates its identifier (when the file has been identified) and in any case its name, path and size.

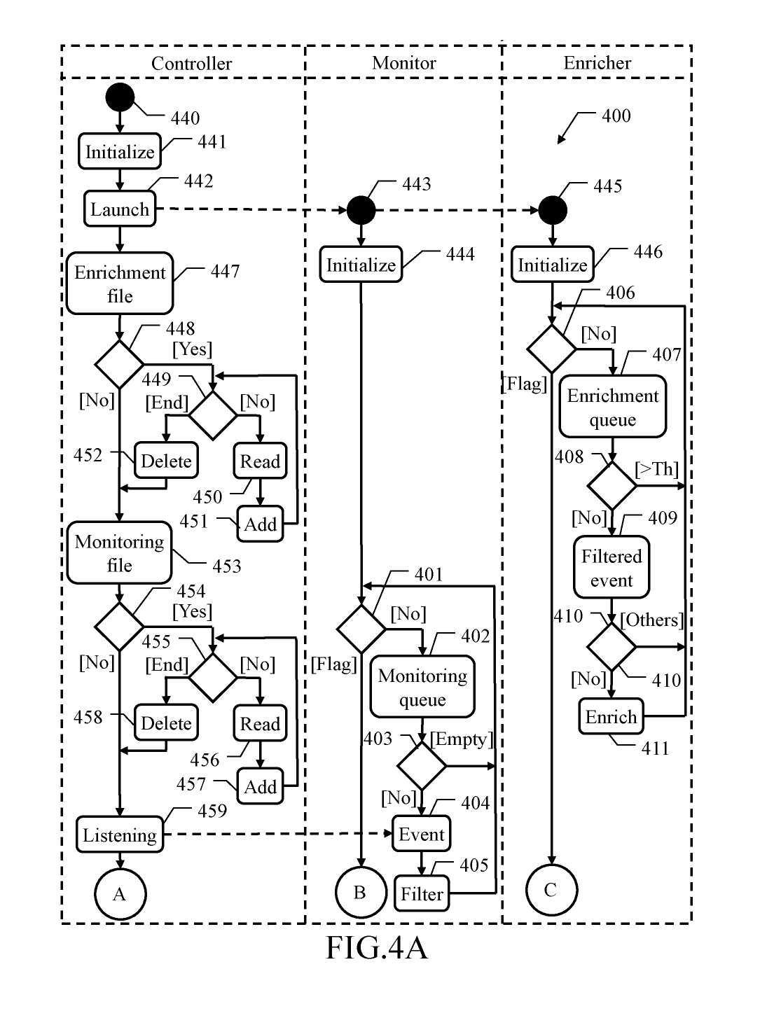

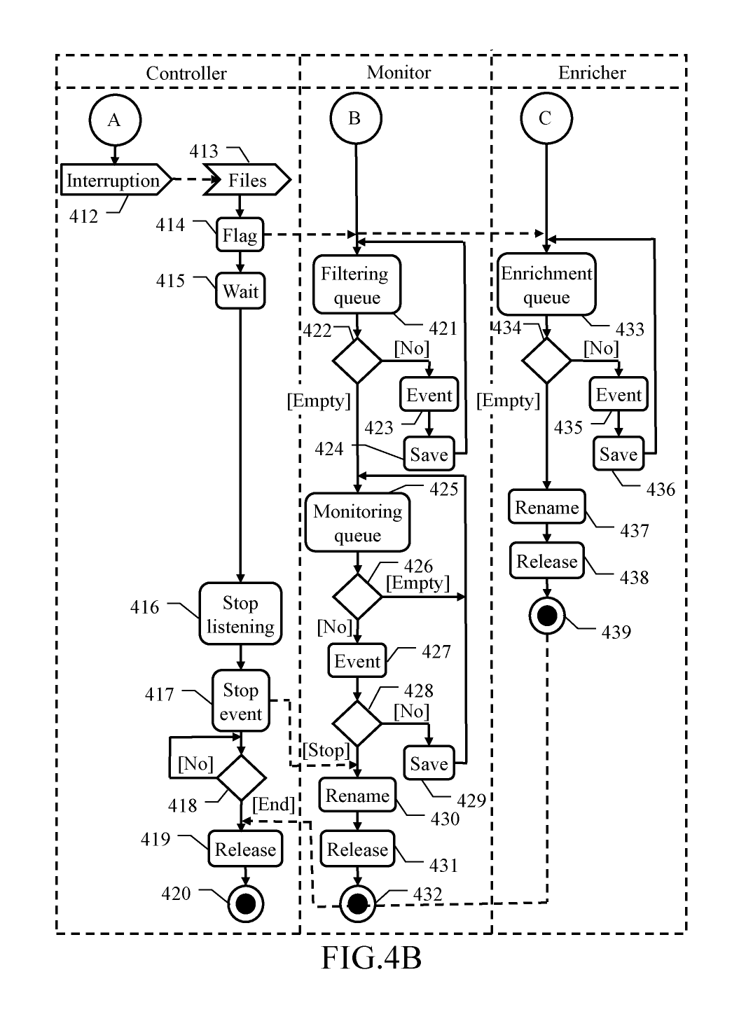

With reference now to FIG. 4A-FIG. 4B, an activity diagram is shown describing the flow of activities relating to an implementation of the solution according to an embodiment of the present disclosure.

Particularly, the diagram represents an exemplary process that may be used to identify the files of a generic endpoint with a method 400. In this respect, each block may correspond to one or more executable instructions for implementing the specified logical function on the endpoint.

Starting from a regular operative condition of the inventory tool, the monitor continually performs a loop for monitoring and filtering the events (relating to the files of the endpoint). Particularly, at block 401 in its swim-lane the monitor verifies an interruption flag. The interruption flag is normally de-asserted (when no interruption signaling has been received); in this case, the process continues to block 402 wherein the monitor verifies the monitoring queue. The process then branches at block 403 according to a result of this verification. If the monitoring queue is empty, the flow of activity returns to the block 401 in an idle loop. Conversely, the flow of activity descends into block 404, wherein the monitor extracts a (current) event from the monitoring queue, i.e., the oldest one from its head; at the same time, the monitor may also log the current event, for example, for diagnostic purposes.

Continuing to block 405, the monitor filters the events that have been monitored into the enrichment queue. For example, when the current event is a modify event (indicating the closing of the corresponding (current) file after it has been modified) or a create event (indicating the creation of the current file being empty or with minimum size), if the filtering queue does not contain any other event of the current file or a difference between the timestamp of the current event and the timestamp of a last (i.e., oldest) event of the current file in the filtering queue is (possibly strictly) higher than a monitoring threshold (for example, 3-5 [s]), the monitor adds the current event to the filtering queue; conversely, the monitor adds this last event to the enrichment queue, removes all the events of the current file from the filtering queue and then adds the current event to the filtering queue. In this way, when a modify sequence is found (consisting of two or more modify events or a create event and one or more modify events of a same file that are separated among them by a period shorter than the monitoring threshold), the last modify event only is maintained (since the current file has been created/modified in rapid succession and then only its content at the end is relevant). Instead, when the current event is a rename event (indicating the renaming of the current file) or a delete event (indicating the deletion of the current file), if the filtering queue contains any other event of the current file the monitor adds a last event thereof to the enrichment queue and then removes all the events of the current file from the filtering queue (so as to process the corresponding modify sequence as above); in any case, the monitor then adds the current event to the enrichment queue. In all the other cases, the current event is discarded since it is not relevant; moreover, if a last event in the filtering queue, i.e., the oldest one (for any file) has its timestamp that is (possibly strictly) older than the monitoring threshold from the current time, the monitor adds it to the enrichment queue and then removes all the events of the same file from the filtering queue (so as to process the corresponding modify sequence as above when no corresponding further event has occurred). The flow of activity then returns to the block 401 to perform the same operations continually.

At the same time, the enricher continually performs a loop for enriching the filtered events. Particularly, at block 406 in its swim-lane the enricher verifies the interruption flag as well. Normally, with the interruption flag that is de-asserted, the process continues to block 407 wherein the enricher verifies the enrichment queue. The process then branches at block 408 according to a result of this verification. If the enrichment queue is empty or the timestamp of a (current) filtered event at its head, i.e., the oldest one, is not (possibly strictly) older than an enrichment threshold from the current time (for example, 5-10 [s]) the flow of activity returns to the block 406 in an idle loop. Conversely, when the timestamp of the current filtered event is older than the enrichment threshold, at block 409 the enricher extracts the current event from the enrichment queue. Continuing to block 410, the enricher verifies whether the enrichment queue contains any (next) filtered event of the (current) file of the current filtered event, i.e., a newer one; if so, the enricher further verifies whether the difference between the timestamp of the next filtered event and the timestamp of the current filtered event is (possibly strictly) higher than the enrichment threshold. If not, the flow of activity returns to the block 406 directly as well (so that the current filtered event is discarded since different operations have been performed on the file in rapid succession and then only its content at the end is relevant).

Referring back to the block 410, if the enrichment queue does not contain any next filtered event of the current file or the difference between the timestamp of the next filtered event and the timestamp of the current filtered event is higher than the enrichment threshold the process descends into block 411. The enricher now calculates the hashes of the current file for all the types indicated in the software catalogue (for example, by reading the current file in advance only once); the enricher then enriches the current filtered event by adding the hashes so calculated and the size of the current file (retrieved from the operating system) and it adds the enriched event so obtained to the identification list. The flow of activity then returns to the block 406 to perform the same operations continually.

The enriched events in the identification list may then be used to identify the corresponding files (not shown in the figure). For example, the identifier continually performs a loop wherein it extracts any (current) enriched event from the identification list and attempts to identify the (current) file of the current enriched event by verifying each hash thereof against the known hashes of the same types in the software catalogue; if a match is found, the current file is identified accordingly (otherwise, it remains unknown). The identifier then updates the software inventory for the current file by adding a new record when the current file has been created, by modifying its record when the current file has been modified/renamed or by removing its record when the current file has been deleted (with the new/modified record comprising the identifier of the current file, or a null value when it is unknown, its name, path and size retrieved from the enriched event). The software inventory may be uploaded (for example, periodically or at any change thereof) to the management server for use by the resource management application, for example, aggregating the software inventories from all the endpoints into a (global) software report indicating all the legitimate software programs, unauthorized software programs or malwares, which may be used for analysis and/or remediation purposes (such as by provisioning additional entitlements for any non-compliance with applicable license conditions, deploying management policies to the endpoints for removing unauthorized software programs, removing or moving to quarantine malwares).

In a completely independent way, the process passes from block 412 to block 413 in the swim-lane of the controller as soon as an interruption signaling is received. The interruption signaling indicates that any interruption of operation of the endpoint has been initiated, thereby causing the loosing of the content of its (volatile) working memory; for example, this happens during a shutdown of the endpoint (wherein a power supply is removed in a controlled way by the operating system that clears its caches so as to complete any pending operations, closes user processes, closes system processes and then switches off a main board) or during a reboot of the endpoint (wherein the endpoint is turned off and then turned on again without removing the power supply, such as during installation of a software program). In response to the interruption signaling, if necessary the controller creates a monitoring temporary file and an enrichment temporary file (for example, with .tmp extension), precursors of the monitoring persistency file and the enrichment persistency file, respectively. Continuing to block 414, the controller asserts the interruption flag (to indicate the receiving of the interruption signaling to the monitor and to the enricher). At this point, the controller enters a waiting condition at block 415, wherein it remains idle for a delay period; the delay period has a length corresponding to the time required by the operating system to complete any pending operations on the files of the endpoint (for example, 5-15 [s], preferably 7-13 [s] and still more preferably 9-11 [s], such as 5 [s]). Once the delay period has passed, the process descends into block 416 wherein the controller stops listening for the events.

The delay period avoids (or at least substantially reduces) any loss of the events occurring during the interruption of operation of the endpoint (thereby further increasing the accuracy and the responsiveness in the identification of the files). On the other hand, the stop of the listening allows discarding events relating to the interruption of operation of the endpoint that are not relevant (thereby avoiding their useless processing at a next restart of the endpoint).

With reference now to block 417, the controller generates a stop event that is added to the monitoring queue (to indicate an ending of the events that are to be saved to the monitor). The controller now enters an idle loop at block 418, waiting for a completion of the saving of the events by the monitor and of the filtered events by the enricher, as indicated by the creation of the monitoring persistency file and the enrichment persistency file, respectively. As soon as the controller finds both the monitoring persistency file and the enrichment persistency file, the process descends into block 419, wherein the controller releases all its resources. The controller then terminates (by closing its thread) at the concentric white/black stop circles 420.

Returning to the block 401 in the swim-lane of the monitor, as soon as the interruption flag has been asserted (by the controller at the block 414, as represented in the figure by an arrow in broken line) the monitor exits the loop for monitoring and filtering the events and enters a loop for saving the events contained in the filtering queue. The loop begins at block 421, wherein the monitor verifies the filtering queue. The process then branches at block 422 according to a result of this verification. If the filtering queue is not empty, the process descends into block 423 wherein the monitor extracts a (current) event from the filtering queue, i.e., the oldest one from its head. The monitor saves the current event by writing it into the monitoring temporary file (at its end) at block 424. The flow of activity then returns to the block 421 to perform the same operations continually. Referring back to the block 422, as soon as the filtering queue is empty the process descends into block 425 to exit the loop for saving the events contained in the filtering queue and to enter a further loop for saving the events contained in the monitoring queue.

This loop begins at the block 425 with the monitor that verifies the monitoring queue. The process then branches at block 426 according to a result of this verification. If the monitoring queue is empty, the flow of activity returns to the block 425 in an idle loop. Conversely, the flow of activity descends into block 427, wherein the monitor extracts a (current) event from the monitoring queue, i.e., the oldest one from its head. The monitor verifies the current event at block 428. If the current event is different from the stop event, at block 429 the monitor saves the current event by writing it into the monitoring temporary file (at its end). The flow of activity then returns to the block 425 to perform the same operations continually. Referring back to the block 428, if the current event is instead the stop event (generated by the controller at the block 417, as represented in the figure by an arrow in broken line) the process descends into block 430 to exit the loop for saving the events contained in the monitoring queue as well.

In this way, the (unfiltered) events that are still to be filtered and possibly still to be monitored are saved in the correct temporal sequence of their generation, i.e., in decreasing order of the corresponding timestamps with the events from the filtering queue followed by the events from the monitoring queue. Moreover, the use of the stop event ensures the saving of all the events generated by the operating system up to the stop of their listening, even if the monitoring queue may be temporary empty after the assertion of the interruption flag.

With reference now to the block 430, the monitor renames the monitoring temporary file into the monitoring persistency file (for example, by changing its extension from .tmp to .dat). The process descends into block 431, wherein the monitor releases all its resources. The monitor then terminates (by closing its thread) at the concentric white/black stop circles 432.

At the same time, returning to the block 406 in the swim-lane of the enricher, as soon as the interruption flag has been asserted (by the controller at the block 414, as represented in the figure by an arrow in broken line) the enricher exits the loop for enriching the events and enters a loop for saving the filtered events contained in the enrichment queue. The loop begins at block 433, wherein the enricher verifies the enrichment queue. The process then branches at block 434 according to a result of this verification. If the enrichment queue is not empty, the process descends into block 435 wherein the enricher extracts a (current) filtered event from the filtering queue, i.e., the oldest one from its head. The enricher saves the current filtered event by writing it into the enrichment temporary file (at its end) at block 436. The flow of activity then returns to the block 433 to perform the same operations continually. Referring back to the block 434, as soon as the enrichment queue is empty the process descends into block 437 to exit the loop for saving the filtered events contained in the enrichment queue. At this point, the enricher renames the enrichment temporary file into the enrichment persistency file (for example, as above by changing its extension from .tmp to .dat). The process descends into block 438, wherein the enricher releases all its resources. The enricher then terminates (by closing its thread) at the concentric white/black stop circles 439.

In this way, the filtered events that are still to be enriched are saved in the correct temporal sequence of their generation, i.e., in decreasing order of the corresponding timestamps.

With reference again to the swim-lane of the controller, whenever the endpoint is started (a first time and then after every interruption of operation thereof) the operating system automatically launches the controller (within its thread) at the black start circle 440 (for example, with the inventory tool that is registered as a service to the operating system). In response, thereto, the controller initializes at block 441 by allocating the resources required for its operation, comprising the interruption flag being de-asserted (but without starting the listening for the events generated by the operating system). The controller then launches the monitor and the enricher at block 442 (as represented in the figure by an arrow in broken line). In response, thereto, the monitor starts (within the corresponding thread) at the black start circle 443 in its swim-lane. The monitor then initializes at block 444 by allocating the resources required for its operation, comprising the monitoring queue and the filtering queue (both of them empty); the flow of activity then continues to the block 401 to enter the loop for monitoring and filtering the events. At the same time, the enricher as well starts (within the corresponding thread) at the black start circle 445 in its swim-lane. The enricher then initializes at block 446 by allocating the resources required for its operation, comprising the enrichment queue (empty); the flow of activity then continues to the block 406 to enter the loop for enriching the filtered events.

Returning to the swim-lane of the controller, it verifies the enrichment persistency file at block 447. The process then branches at block 448 according to a result of this verification. If the enrichment persistency file has been found (as created during a previous interruption of operation of the endpoint), the controller enters a loop for restoring the filtered events (still to be enriched) saved into the enrichment persistency file. The loop begins at block 449, wherein the controller verifies whether an end of the enrichment persistency file has been reached. If not, at block 450 the controller reads a (current) filtered event from the enrichment persistency file (in succession from its beginning). The controller restores the current filtered event by adding it to the enrichment queue (at its tail) at block 451. The flow of activity then returns to the block 449 to perform the same operations continually. With reference again to the block 449, as soon as the end of the enrichment persistency file has been reached the loop for restoring the filtered events is exit by descending into block 452 (immediately when the enrichment persistency file is empty); at this point, the controller deletes the enrichment persistency file.

The flow of activity then continues from the block 452 to block 453, with the same point that is also reached directly from the block 448 if the enrichment persistency file has not been found; the controller now verifies the monitoring persistency file. The process then branches at block 454 according to a result of this verification. If the monitoring persistency file has been found (as created during a previous interruption of operation of the endpoint), the controller enters a loop for restoring the events (still to be filtered) saved into the monitoring persistency file. The loop begins at block 455, wherein the controller verifies whether an end of the monitoring persistency file has been reached. If not, at block 456 the controller reads a (current) event from the monitoring persistency file (in succession from its beginning). The controller restores the current event by adding it to the monitoring queue (at its tail) at block 457. The flow of activity then returns to the block 455 to perform the same operations continually. With reference again to the block 455, as soon as the end of the monitoring persistency file has been reached the loop for restoring the events is exit by descending into block 458 (immediately when the monitoring persistency file is empty); at this point, the controller deletes the monitoring persistency file.

In this way, both the events (which are still to be filtered) and the filtered events (which are still to be enriched) are restored to the monitoring queue and to the enrichment queue, respectively, in the correct temporal sequence of their generation, i.e., in decreasing order of the corresponding timestamps. Moreover, the restoring of the monitoring queue after the restoring of the enrichment queue ensures that the (next) filtered events that are generated (from the events being restored and then from the events being monitored) are added to the enrichment queue correctly after the (previous) filtered events being restored. In any case, the deletion of the enrichment persistency file and of the monitoring persistency file after the restoring has been completed of the filtered events and of the events, respectively, avoids any loss thereof even if the operation of the endpoint is interrupted in the meanwhile.

The flow of activity then continues from the block 458 to block 459; the same point is also reached directly from the block 454 if the enrichment persistency file has not been found. The controller now restarts the listening for the events generated by the operating system (so as to restart their monitoring by the monitor at the block 404, as represented in the figure by an arrow in broken line). The flow of activity then continues to the block 412 waiting for the interruption signaling.

In this way, the inventory tool returns to its regular operative condition described above; however, the filtered events and the events being restored from the enrichment persistency file and the monitoring persistency file, respectively (i.e., generated before the previous interruption of operation of the endpoint) are processed correctly before the (next) events being generated by the operating system. In any case, the resulting delay in the restarting of the listening from the start of the endpoint does not create any problem in practice. Indeed, the restoring of the filtered events and of the events is very simple and fast; therefore, the delay is very short and in most practical situations shorter than the time required to complete a bootstrap of the endpoint, so that the corresponding events that may be lost are not relevant.

Naturally, in order to satisfy local and specific requirements, a person skilled in the art may apply many logical and/or physical modifications and alterations to the present disclosure. More specifically, although this disclosure has been described with a certain degree of particularity with reference to one or more embodiments thereof, it should be understood that various omissions, substitutions and changes in the form and details as well as other embodiments are possible. Particularly, different embodiments of the present disclosure may even be practiced without the specific details (such as the numerical values) set forth in the preceding description to provide a more thorough understanding thereof; conversely, well-known features may have been omitted or simplified in order not to obscure the description with unnecessary particulars. Moreover, it is expressly intended that specific elements and/or method steps described in connection with any embodiment of the present disclosure may be incorporated in any other embodiment as a matter of general design choice. In any case, each numerical value should be read as modified by the term about (unless already done) and each range of numerical values should be intended as expressly specifying any possible number along the continuum within the range (comprising its end points). Moreover, ordinal or other qualifiers are merely used as labels to distinguish elements with the same name but do not by themselves connote any priority, precedence or order. The terms include, comprise, have, contain and involve (and any forms thereof) should be intended with an open, non-exhaustive meaning (i.e., not limited to the recited items), the terms based on, dependent on, according to, function of (and any forms thereof) should be intended as a non-exclusive relationship (i.e., with possible further variables involved), the term a/an should be intended as one or more items (unless expressly indicated otherwise), and the term means for (or any means-plus-function formulation) should be intended as any structure adapted or configured for carrying out the relevant function.

For example, an embodiment provides a method for identifying software components in a computing system. However, the software components may be of any type (for example, executable programs, plug-ins, libraries, macros, configurations) in any computing system (see below); moreover, the method may be performed at any time (for example, continually, periodically).

In an embodiment, the method includes monitoring events relating to one or more software components of the computing system. However, the events may be monitored in any way (for example, with listening, intercepting, hooking techniques, either in user mode or in kernel mode) for any number of software components (for example, indiscriminately or only for selected types, such as executable programs); moreover, the events may be of any type (for example, create, modify, rename, delete, open, close, write, read, load, execute) and issued by any entity (for example, the operating system, a middleware, an application program).

In an embodiment, the method includes processing the events for use to identify the software components. However, the events may be processed in any way (for example, monitored, filtered, enriched and/or analyzed) for identifying the software components in any way (for example, by their product name, version, service level, publisher, mnemonic description, product code or any combination thereof) and at any time (either during or after the processing of the events). This information may be used for any purpose (for example, for inventorying legitimate software programs, discovering unauthorized software programs, detecting malwares, analyzing deviations such as caused by a same file with different size on some endpoints or any combination thereof); particularly, the information may be used either for reporting only or for performing corresponding management activities as well (for example, by removing files, moving files to quarantine, applying patches) in any way (for example, by deploying policies for the management activities, enforcing the management activities directly).

In an embodiment, the method includes receiving an interruption signaling indicative of an interruption of operation of the computing system that is initiated. However, the interruption signaling may be received in any way (for example, via a message, an interrupt) from any entity (for example, the operating system, the firmware of the computing system); the interruption signaling may indicate any interruption of operation (for example, a shutdown, a cold reboot, a warm reboot) at any phase of its initiation (for example, immediately at its starting, after clearing the caches).

In an embodiment, the method includes saving any pending events (of the events having said processing thereof being not completed) from a volatile memory to a non-volatile memory of the computing system in response to the interruption signaling. However, the pending events may be at any stage of their processing (for example, events still to be monitored, filtered, enriched and/or analyzed); moreover, the pending events may be saved in any way (for example, into any number of files, tables down to a single one for all of them) and at any time after the interruption signaling (for example, after a delay or immediately, all together or in succession for different types defined by a progress of their processing, such as events still to be monitored, filtered, enriched and/or analyzed).

In an embodiment, the method includes restoring the pending events from the non-volatile memory to the volatile memory for said processing thereof in response to a restarting of the operation of the computing system following the interruption thereof. However, the pending events may be restored in any way (for example, into queues, registers, arrays) and for processing them starting from any stage thereof (for example, for their monitoring, filtering, enriching and/or analyzing).

In an embodiment, the method includes stopping said monitoring the events in response to the interruption signaling. However, the monitoring of the events may be stopped at any time after the interruption signaling (for example, with a delay, immediately or even never).

In an embodiment, the method includes waiting for a delay period from the interruption signaling before stopping said monitoring the events. However, the delay period may have any value (for example, fixed or depending on the completion of any pending operations).

In an embodiment, the method includes restarting said monitoring the events after the restarting of the operation of the computing system in response to a completion of said restoring the pending events. However, the monitoring of the events may be restarted at any time after restoring the pending events (for example, immediately or with a delay, either fixed or depending on a completion of the restarting of the computing system); in any case, the possibility of restarting the monitoring of the events immediately after the restarting of the operation of the computing system is not excluded (for example, when the order of processing of the events is not a constraint).

In an embodiment, the method includes filtering at least part of the events into filtered events. However, the events may be filtered in any way (for example, according to event sequences relating to any logical operations, predefined types of events, events in rapid succession).

In an embodiment, the filtering of the events results in producing an enrichment queue with the filtered events. However, the filtered events may be of any type (either the same or different with respect to the corresponding events as monitored) and they may be produced by any entity with an enrichment queue of any length.

In an embodiment, the method includes consuming the filtered events from the enrichment queue. However, the synchronization between the producer and the consumer of the filtered events may be implemented in any way (for example, with a FIFO queue, a channel, semaphores, monitors).

In an embodiment, the method includes enriching the filtered events consumed from the enrichment queue into enriched events with additional information relating to the corresponding software components for use to identify the software components. However, the filtered events may be enriched with any additional information (for example, their signature, size, version or any combination thereof).

In an embodiment, the method includes saving the filtered events from the enrichment queue into the non-volatile memory in response to the interruption signaling. However, the filtered events may be saved in any way (for example, into a dedicated structure or a shared structure).

In an embodiment, the method includes restoring the enrichment queue with the filtered events from the non-volatile memory in response to the restarting of the operation of the computing system. However, the enrichment queue may be restored in any way (for example, by reading the filtered events individually, at blocks or all together).

In an embodiment, the method includes filtering the events according to finalizing events of corresponding event sequences ending with the finalizing events. However, the events may be filtered in any way (for example, by discarding all the events different from the finalizing events, discarding finalizing events relating to a same software component that are in short succession, maintaining the events that are not part of any event sequences).

In an embodiment, each of the event sequences relates to a logical operation for a current software component of the software components that is finalized by the corresponding finalizing event. However, the event sequences may be detected in any way (for example, by storing the events temporarily into one or more filtering queues, analyzing them directly as they are received, such as by discarding specific types thereof indiscriminately); moreover, the event sequences may relate to any logical operations (for example, modify, create, rename, delete) and the event sequences may have any length and they may be identified by any finalizing events (for example, when a file is closed, a predefined period passed without any further operation on a file).

In an embodiment, the method includes enriching the filtered events consumed from the enrichment queue by adding current signatures of the corresponding current software components. However, each current signature may be formed by any number of items each of any type (for example, hash values, fingerprints, checksums).

In an embodiment, each of the current signatures is determined according to at least part of a content of the corresponding current software component. However, the current signature may be determined in any way (for example, with any cryptographic hash function such as SHA, MD5, RIPEMD, with an invertible hash function) according to any part of the content of the corresponding current software component (for example, all its content, a single segment thereof, two of more non-contiguous segments identified in any way, such as by wildcards, fixed positions, being read either once for multiple hash values or repeatedly for each of them).

In an embodiment, the current signature is used to identify the current software component according to a comparison of the current signature with one or more known signatures of known software components. However, the known signatures may be provided in any way (for example, in one or more catalogues, blacklists, databases) for any known software components (for example, legitimate software programs, unauthorized software programs, malwares). Moreover, the operation of identifying the current software component may be performed according to any comparison of its current signature with the known signatures (for example, by exact matches only or by inexact matches as well) and at any location (for example, locally on each endpoint or centrally in a server that receives the current signatures from each endpoint).

In an embodiment, the method includes monitoring the events by consuming the events from a monitoring queue produced by an operating system of the computing system. However, the events may include any information (sufficient to identify them) and they may be produced/consumed by any entities with a monitoring queue of any length; in any case, the corresponding synchronization may be implemented in any way (either the same or different with respect to the one relating to the filtered events).

In an embodiment, the method includes saving unfiltered events (comprising the events from the monitoring queue) into the non-volatile memory in response to the interruption signaling. However, the unfiltered events may be saved in any way (for example, alone or together with the filtered events).

In an embodiment, the method includes restoring the monitoring queue with the unfiltered events from the non-volatile memory in response to the restarting of the operation of the computing system. However, the monitoring queue may be restored in any way (either the same or different with respect to the enrichment queue).

In an embodiment, the method includes adding a stop event to the monitoring queue in response to the interruption signaling. However, the stop event may be of any type and it may be added to the monitoring queue at any time after the interruption signaling (for example, with a delay, immediately).

In an embodiment, the method includes terminating said saving the unfiltered events in response to a reaching of the stop event in the monitoring queue. However, the saving of the unfiltered events may be stopped in different ways (for example, simply when the monitoring queue is empty).

In an embodiment, the method includes storing at least part of the events temporally into at least one filtering queue for filtering the events. However, the filtering queues may be in any number and of any type (for example, a common structure for all the software components or individual structures for different software components) for saving any number and types of events (for example, only modify events, modify events and create events).

In an embodiment, the method includes saving the unfiltered events comprising the events from said at least one filtering queue followed by the events from the monitoring queue into the non-volatile memory in response to the interruption signaling. However, the events from the monitoring queue and the filtering queue may be saved in any way (for example, into a single structure indistinctly or separated between them, into corresponding structures) for restoring them in any way (for example, all of them into the monitoring queue or into the monitoring queue and the filtering queue, respectively).

In an embodiment, the method includes restoring the monitoring queue after a completion of said restoring the enrichment queue. However, the monitoring queue and the enrichment queue may be restored at any other time (for example, concurrently by restarting the enrichment of the filtered events only after the monitoring queue has been restored or even indiscriminately when the order of processing of the events is not a constraint).

In an embodiment, the method includes asserting at least one interruption flag in response to the interruption signaling. However, the interruption flags may be of any type and in any number (for example, a common flag or multiple dedicated flags for triggering the saving of the events to be monitored, the events to be filtered, all the unfiltered events and/or the filtered events).

In an embodiment, the method includes triggering said saving the unfiltered events in response to said at least one interruption flag being asserted. However, the saving of the unfiltered events may be triggered in any way (for example, in response to the assertion of a common/dedicated flag, a message, an interrupt).

In an embodiment, the method includes triggering said saving the filtered events in response to said at least one interruption flag being asserted. However, the saving of the filtered events may be triggered in any way (either the same or different with respect to the saving of the unfiltered events).

In an embodiment, the method includes writing the pending events into one or more temporary files of the non-volatile memory in response to the interruption signaling. However, the temporary files may be of any type (for example, with any extensions and/or names) and in any number (for example, dedicated files for the unfiltered events and the filtered events, dedicated files for the events to be monitored and the events to be filtered, a common file for all the pending events).

In an embodiment, the method includes renaming the temporary files into corresponding persistency files in response to corresponding completions of said writing the pending events. However, the temporary files may be renamed in any way (for example, by changing their extensions and/or names) into any number of persistency files (either the same or different with respect to the temporary files); in any case, the completion of the writing of the persistency files may be signaled in any other way (for example, by writing them directly and then using corresponding flags, messages).

In an embodiment, the method includes restoring the pending events from the persistency files. However, the pending events may be restored from the persistency files in any way (for example, into one or more queues for each persistency file).

In an embodiment, the method includes deleting the persistency files in response to corresponding completions of said restoring the pending events from the persistency files. However, the completion of the restoring of the pending events may be signaled in any other way (for example, without deleting them and then using corresponding flags, messages).

Generally, similar considerations apply if the same solution is implemented with an equivalent method (by using similar steps with the same functions of more steps or portions thereof, removing some steps being non-essential, or adding further optional steps); moreover, the steps may be performed in a different order, concurrently or in an interleaved way (at least in part).

An embodiment provides a computer program configured for causing a computing system to perform the above-mentioned method. An embodiment provides a computer program product comprising a computer readable storage medium having program instructions embodied therewith, the program instructions executable by a computing system to cause the computing system to perform the same method. However, the computer program may run on any computing system (see below). Moreover, the software program may be implemented as a stand-alone module, as a plug-in for a pre-existing software program (for example, the inventory tool) or even directly in the latter. In any case, the solution according to an embodiment of the present invention lends itself to be implemented even with a hardware structure (for example, by electronic circuits integrated in one or more chips of semiconductor material), or with a combination of software and hardware suitably programmed or otherwise configured.

An embodiment provides a system comprising means configured for performing the steps of the above-mentioned method. An embodiment provides a system comprising a circuitry (i.e., any hardware suitably configured, for example, by software) for performing each step of the same method. However, the method may be performed on any number and type of endpoints (for example, desktops, laptops, smartphones, tablets) that are managed by any server (for example, a physical computing machine, a virtual computing machine, a cloud service) communicating among them via any network (for example, of local, wide area, global, cellular or satellite type); in any case, the method may also be implemented on any stand-alone computing machine.

Generally, similar considerations apply if the system has a different structure or includes equivalent components or it has other operative characteristics. In any case, every component thereof may be separated into more elements, or two or more components may be combined together into a single element; moreover, each component may be replicated to support the execution of the corresponding operations in parallel. Moreover, unless specified otherwise, any interaction between different components generally does not need to be continuous, and it may be either direct or indirect through one or more intermediaries.

The present invention may be a system, a method, and/or a computer program product. The computer program product may include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Computer readable program instructions described herein can be downloaded to respective computing/processing devices from a computer readable storage medium or to an external computer or external storage device via a network, for example, the Internet, a local area network, a wide area network and/or a wireless network. The network may include copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention. Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions. These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein includes an article of manufacture including instructions which implement aspects of the function/act specified in the flowchart and/or block diagram block or blocks. The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks. The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which includes one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The present invention may be embodied as a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may include copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object-oriented programming language such as Smalltalk, C++ or the like, and conventional procedural programming languages, such as the “C” programming language or similar programming languages. The computer readable program instructions may execute entirely on the user's computer, partly on the user's computer as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus', and/or other devices to function in a particular manner, such that the computer readable storage medium having instructions stored therein includes an article of manufacture including instructions which implement aspects of the function/act specified in the flowchart and/or block diagram block or blocks.

The computer readable program instructions may also be loaded onto a computer, other programmable data processing apparatus, or another device to cause a series of operational steps to be performed on the computer, other programmable apparatus or other device to produce a computer implemented process, such that the instructions which execute on the computer, other programmable apparatus, or another device implement the functions/acts specified in the flowchart and/or block diagram block or blocks.

The flowcharts and/or block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which includes one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or act or carry out combinations of special purpose hardware and computer instructions.

The terminology used herein is for the purpose of describing particular embodiments only and is not intended to limit the invention. As used herein, the singular forms “a”, “an” and “the” are intended to include the plural forms as well, unless the context clearly indicates otherwise. It will further be understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or steps plus function elements in the claims below are intended to include any structure, material, or act for performing the function in combination with other claimed elements, as specifically claimed. The description of the present invention has been presented for purposes of illustration and description, but is not intended to be exhaustive or limited to the invention in the form disclosed. Many modifications and variations will be apparent to those of ordinary skills in the art without departing from the scope and spirit of the invention. The embodiments are chosen and described in order to best explain the principles of the invention and the practical application, and to enable others of ordinary skills in the art to understand the invention for various embodiments with various modifications, as are suited to the particular use contemplated.

The descriptions of the various embodiments of the present invention have been presented for purposes of illustration, but are not intended to be exhaustive or limited to the embodiments disclosed. The terminology used herein was chosen to explain the principles of the one or more embodiments, the practical application or technical improvement over technologies found in the marketplace, or to enable others of ordinary skill in the art to understand the embodiments. Various modifications, additions, substitutions, and the like will be apparent to those of ordinary skill in the art without departing from the scope and spirit of the invention, as defined in the following claims.

What is claimed is:

1. A method for identifying software components in a computing system, the method comprising:
monitoring events relating to one or more software components of the computing system;
processing the events for use to identify the software components;
receiving an interruption signal indicative of an interruption of operation of the computing system being initiated;
saving pending events from a volatile memory to a non-volatile memory of the computing system in response to the interruption signal, wherein pending events comprise the events having said processing thereof being not completed; and
restoring the pending events from the non-volatile memory to the volatile memory for said processing thereof in response to a restarting of the operation of the computing system following the interruption thereof.

2. The method of claim 1, further comprising:
stopping said monitoring the events in response to the interruption signal.

3. The method of claim 2, further comprising:
waiting for a delay period from the interruption signal before stopping said monitoring the events.

4. The method of claim 1, further comprising:
restarting said monitoring the events after the restarting of the operation of the computing system in response to a completion of said restoring the pending events.

5. The method of claim 1, further comprising:
filtering at least part of the events into filtered events thereby producing an enrichment queue with the filtered events;
consuming the filtered events from the enrichment queue;
enriching the filtered events consumed from the enrichment queue into enriched events with additional information relating to the corresponding software components for use to identify the software components;
saving the filtered events from the enrichment queue into the non-volatile memory in response to the interruption signal; and
restoring the enrichment queue with the filtered events from the non-volatile memory in response to the restarting of the operation of the computing system.

6. The method of claim 5, further comprising:
filtering the events according to finalizing events of corresponding event sequences ending with the finalizing events, each of the event sequences relating to a logical operation for a current software component of the software components being finalized by the corresponding finalizing event; and
enriching the filtered events consumed from the enrichment queue by adding current signatures of the corresponding current software components, each of the current signatures being determined according to at least part of a content of the corresponding current software component for use to identify the current software component according to a comparison of the current signature with one or more known signatures of known software components.

7. The method of claim 5, further comprising:
monitoring the events by consuming the events from a monitoring queue produced by an operating system of the computing system;
saving unfiltered events comprising the events from the monitoring queue into the non-volatile memory in response to the interruption signal; and
restoring the monitoring queue with the unfiltered events from the non-volatile memory in response to the restarting of the operation of the computing system.

8. The method of claim 7, further comprising:
adding a stop event to the monitoring queue in response to the interruption signal; and
terminating said saving the unfiltered events in response to a reaching of the stop event in the monitoring queue.

9. The method of claim 7, further comprising:
storing at least part of the events temporally into at least one filtering queue for filtering the events; and
saving the unfiltered events comprising the events from said at least one filtering queue followed by the events from the monitoring queue into the non-volatile memory in response to the interruption signal.

10. The method of claim 7, wherein restoring the monitoring queue comprises restoring the monitoring queue after a completion of restoring the enrichment queue.

11. The method of claim 7, further comprising:
asserting at least one interruption flag in response to the interruption signal;
triggering said saving the unfiltered events in response to said at least one interruption flag being asserted; and
triggering said saving the enriched events in response to said at least one interruption flag being asserted.

12. The method of claim 1, further comprising:
writing the pending events into one or more temporary files of the non-volatile memory in response to the interruption signal;
renaming the temporary files into corresponding persistency files in response to corresponding completions of said writing the pending events;
restoring the pending events from the persistency files; and
deleting the persistency files in response to corresponding completions of said restoring the pending events from the persistency files.

13. A computer program product for identifying software components in a computing system, the computer program product comprising:
one or more computer-readable storage devices and program instructions stored on at least one of the one or more tangible storage devices, the program instructions comprising:
program instructions to monitor events relating to one or more software components of the computing system;
program instructions to process the events for use to identify the software components;
program instructions to receive an interruption signal indicative of an interruption of operation of the computing system being initiated;
program instructions to save any pending events of the events having said processing thereof being not completed from a volatile memory to a non-volatile memory of the computing system in response to the interruption signal; and
program instructions to restore the pending events from the non-volatile memory to the volatile memory for said processing thereof in response to a restarting of the operation of the computing system following the interruption thereof.

14. A computer system for identifying software components in a computing system, the computer system comprising:
one or more processors, one or more computer-readable memories, one or more computer-readable tangible storage devices, and program instructions stored on at least one of the one or more storage devices for execution by at least one of the one or more processors via at least one of the one or more memories, the program instructions comprising:
program instructions to monitor events relating to one or more software components of the computing system;
program instructions to process the events for use to identify the software components;
program instructions to receive an interruption signal indicative of an interruption of operation of the computing system being initiated;
program instructions to save any pending events of the events having said processing thereof being not completed from a volatile memory to a non-volatile memory of the computing system in response to the interruption signal; and
program instructions to restore the pending events from the non-volatile memory to the volatile memory for said processing thereof in response to a restarting of the operation of the computing system following the interruption thereof.
